(19) United States
(12) Patent Application Publication
(10) Pub. No.: US 2017/0336764 A1
(43) Pub. Date: Nov. 23, 2017

(54) Machine Learning and Robust Automatic Control of Complex Systems with Stochastic Factors

(71) Applicant: Douglas A. Samuelson, Annandale, VA (US)

(72) Inventor: Douglas A. Samuelson, Annandale, VA (US)

(21) Appl. No.: 15/524,346

(22) PCT Filed: Nov. 4, 2015
(86) PCT No.: PCT/US2015/059000

§ 371 Date: May 4, 2017

Related U.S. Application Data
(60) Provisional application No. 62/074,832, filed on Nov. 4, 2014.

(51) Int. Cl. G05B 13/04; G05B 13/02

(52) U.S. Cl. CPC G05B 13/041; G05B 13/0265

(57) ABSTRACT

Given a set of input data and one or more performance metrics, this method searches directly for a region of specified size, said size representing a selected amount of random variation of the data that provides a preferred, but not necessarily optimal, value of the performance metric across the region. Repeated executions of this method over time yield a good, but not necessarily provably optimal, path through unstable conditions, as for a vessel or aircraft seeking a relatively quick path through changing turbulence. Using repeated executions to derive paths also supports selection of smooth automatic control, over time, of a system subject to random variations in conditions, this method greatly reduces sharp changes in control parameters as conditions change, while selecting good sets of control parameters at each re-computation.

This application claims the benefit of U.S. Provisional Application No. 62/074,832 filed Nov. 4, 2014, which is hereby incorporated by reference in its entirety as if fully set forth herein.

### FIELD OF THE INVENTION

This invention pertains to systems in which varying one or more factors yields better performance, but the precision of the variation of the factors and/or the effect on the performance measure is subject to some random variation.

### BACKGROUND OF THE INVENTION

Automatic control systems are employed in many areas of activity, including manufacturing production; computer and communication networks; and routing of vehicles, aircraft, missiles, and ships. Many such automatic control systems encounter the problem of uncertainty in the requisite data and/or random variation in application and effect of control factors. As is well known to persons versed in the art, attempts to find the precise optimum settings of the control factors often result in optima that are “brittle,” that is, theoretically the best, but subject to considerable degradation in case of small random variations. There is a need, therefore, for a method that produces near-optima that require much less detailed data and are robust against small variations in the control variables.

### SUMMARY OF THE INVENTION

The invention in a reliable, easily computed, easily repeatable way produces “good-enough” solutions much more quickly and inexpensively than methods that search for the provable best solution. In addition, the invention makes it possible and desirable to find such a “good-enough” solution that is, in fact, better than the “best” solution if there are small variations and errors in the data used for the calculations.

To improve the performance of systems of this type, the invention applies principles of operations research, management science and related disciplines, especially stochastic optimization and automatic control. An automated system operating on a computer computes and updates estimates of durations of key activities and uses these estimates to calculate expected performance of the system for a number of combinations of settings of the controllable activities. Instead of seeking a single optimal set of values for the control factors, however, the system then selects the combination of factor inputs that provides the highest expected performance given a range of the control factors. In other words, the system selects not the single best set of values but the range of sets of values that more stably provides near-optimal performance even if some of the settings or responses are off the best possible by a little.

Given a set of input data and one or more performance metrics, this method searches directly for a region of specified size, said size representing a selected amount of random variation of the data that provides a preferred, but not necessarily optimal, value of the performance metric across the region. This is like searching for a high plateau in a mountain range, wide enough that random variations in wind will not carry a parachutist off the plateau, rather than seeking the highest point in the vicinity. Repeated executions of this method over time yield a good, but not necessarily provably optimal, path through unstable conditions, as for a vessel or aircraft seeking a relatively quick path through changing turbulence. Using repeated executions to derive paths also supports selection of smooth automatic control, over time, of a system subject to random variations in conditions, such as a telephone call center, as this method greatly reduces sharp changes in control parameters as conditions change, while selecting good sets of control parameters at each re-computation.

The invention provides a method for finding a set of points within a large, multidimensional set of points, such that the identified set is highly likely to offer desired values of one or more performance metrics. The following steps are used:
(1) Define one or more metrics of performance of the system, and one or more control factors.
(2) Compute a range for each control factor representing the estimated random variation of that control factor in application. For example, if the 95 percent confidence interval of a control factor is +/−3, the range for this purpose would be 6. These ranges, in combination for all control factors, define a “patch,” that is, a rectangle or hyper-rectangle, a different shape, such as a hyper-ellipsoid, could be used without departing from the scope of this invention.
(3) Select a set of such patches that adjoin each other without overlapping and span the space of values of interest. Said space could be the entire space of possible sets of values or a selected subset.
(4) Compute, via simulation or other calculation, estimated value of said performance metrics for each of a plurality of patches, each of which represents a combinations of control factors, said plurality of patches constituting a grid that is spread through the set or space of possible sets of values, each such point representing a patch.
(5) For each such patch, designated by its centroid, compute a metric of performance from the performance metrics associated with each point in the patch. In a preferred embodiment, this metric is the minimum value of the performance metric for any point in the patch. In another preferred embodiment, this metric is the mean of the values of the performance metric associated with the points in the patch. Other such statistics of performance can also be utilized without departing from the scope of this invention.
(6) Select the patch or a few patches having the most preferred value of the computed metric.
(7) If desired, evaluate patches that partially overlap the patches selected in the previous step, to seek additional improvement.

Selecting a set of patches in Step 3 is simple enumeration of values associated with patches, evaluated over the set of patches that span the entire space.

Selecting a set of patches in Step 3 is response surface estimation, treating the set of patches as elements of a split plot or factorial experimental design, or similar estimation methods.

Statistical or other methods to select only specified patches to evaluate in Step 5.

Repeated applications of the method identify one or more successions of contiguous regions within a multidimensional space, each said succession constituting a path to be traversed over time through said multidimensional space.

The performance metric in each step is a shortest distance or shortest time, and the paths thus generated are then compared to find the expected approximate shortest path overall.

Characteristics of said multidimensional space, or of portions thereof, may change over time.

Smoothing parameters are computed to derive a path among selected sets of parameter values, over time, to select a collection of sets of values that yield preferred performance metrics at each time step and that have small variation in the control parameters from time step to time step.

The multidimensional space constitutes elements of information, and the search for approximate preferred values of the desired metric, in sets (patches) of values of other variables. The selection of the chosen set of patches decreases sensitivity of the desired metric to changes caused by variations on the other variables and is utilized as a method of machine learning.

These and further and other objects and features of the invention are apparent in the disclosure, which includes the above and ongoing written specification, with the drawings.

### BRIEF DESCRIPTION OF THE DRAWINGS

FIG. 1 is a graphical representation of an example of the invention, showing the principle of finding the best bracket, said bracket representing the range of uncertainty in the control (input) factor, where that bracket may not include the maximum single value of the output functions.

FIG. 2 is another graphical representation of an example of the invention, showing the principle of finding the best or nearly best bracket, said bracket A representing the range of uncertainty in the control (input) factor, where that bracket includes but it not centered around the maximum single value of the output function within the bracket.

FIG. 3 is a flowchart schematic showing the major logical steps in the process herein described to find a single patch representing the best or nearly best set of values of the performance metric.

FIG. 4 is a more detailed flowchart showing the logic of the search step.

FIG. 5 is a graphical representation of an example of the invention similar to FIG. 2, in which a good patch A is found in the space-covering first search but then, following step 7 of the method described above, additional search finds better patch B.

FIG. 6 is a flowchart schematic showing the major logical steps in the process herein described to find a path comprising a set of patches, representing the best or nearly best path from a specified origin to a specified destination, nearly minimizing cost or distance taking uncertainties into account.

### DETAILED DESCRIPTION

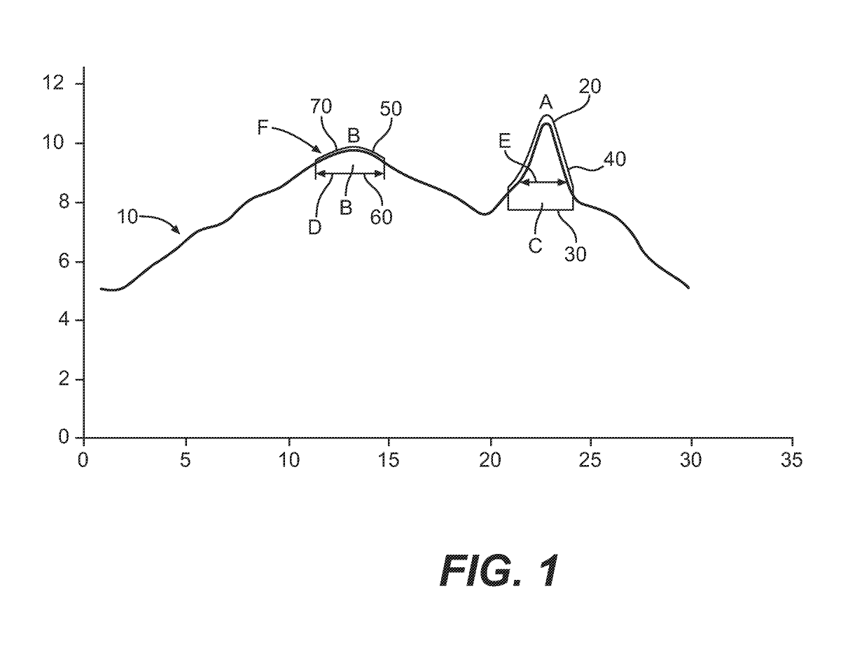

FIG. 1 displays a graph 10 of a representative relationship between a performance metric and the possible values of one control factor. The maximum of the performance metric is at point A, item 20 in the drawing, but the uncertainty of setting the control factor implies that the actual setting is represented by bracket C, item 30. This in turn causes the actual performance metric to fall somewhere along section E, item 40, of the graph. The method of the present invention selects bracket D, item 60 in the drawing, to set the control factor near point B, item 50, of the graph. This yields performance somewhere in Section F, item 70, of the graph. Hence this method does not attain the maximum possible value of the performance metric but does produce a higher expected value of the performance metric than bracket C.

It is readily apparent that the same logic applies to a multi-dimensional representation of a system with several control factors, or to finding a set of such brackets or “patches” that combine to form a good path.

This approach in its closed mathematical form is well known to those skilled in the art. It is called stochastic programming, or stochastic optimization. It requires that the probability distribution of the performance metric as a function of the control factors be fully and precisely specified, along with the values and/or probability distributions of the control factors. In many real systems, however, such detailed and precise data are not available, or are subject to change sufficiently rapid to preclude timely calculation of the stochastic optimum.

The present invention improves on traditional stochastic optimization by using massively parallel calculations and/or simulations to approximate stochastic optimization without the need to specify probability distributions. Values of the performance metric are computed, via some direct method, experimentation, or simulation, for numerous settings of the control factors. The present invention's method then finds the minimum, average, or other function of the performance metrics for multiple sets of settings within a set of ranges, and compares these summary statistics to select the set of ranges—that is, the placement of the bracket comprising the ranges of settings—that yields the maximum of that function. This new method is Robust Adaptive Stochastic Programming (RASP™).

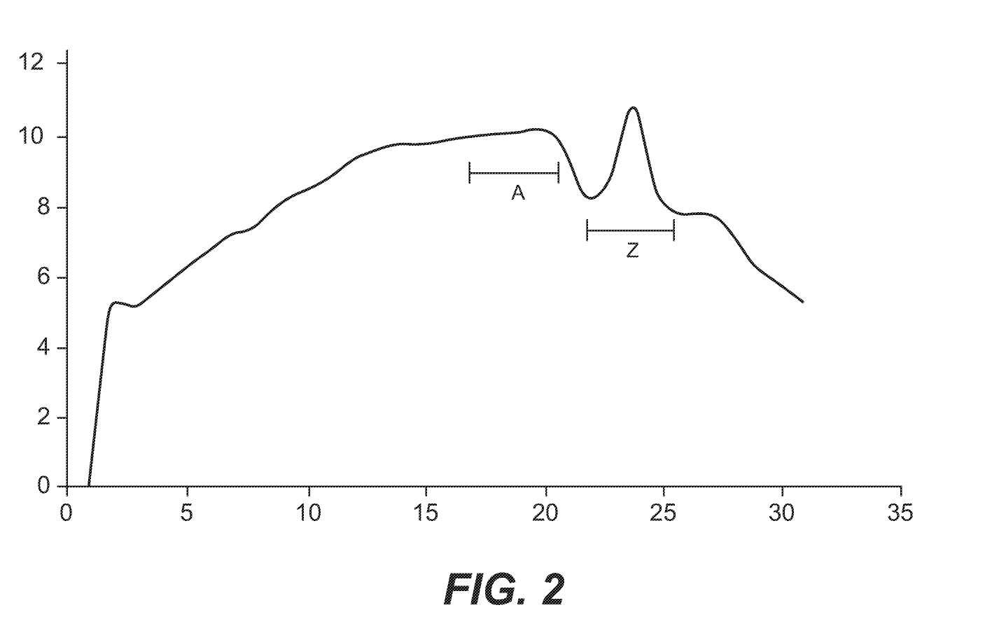

The present method also improves on prior art by directly seeking a best region, rather than finding good points and then computing regions around these points. In most prior art, each region thus computed is symmetric about the corresponding point. (See, for example, J. P. C. Kleijnen, “Adjustable Parameter Design with Unknown Distributions,” Discussion Paper No. 2013-022, Tilburg University, 2013, which also contains a good summary of previous work.) FIG. 2 illustrates why such symmetry is not desirable. In graph 10, selecting optimal point A 20 and then finding symmetric interval C 30 around that point yields an undesirably high probability of obtaining an actual value in region E 40. Interval D 60 is a better choice, as it yields higher values throughout than many of the values in Interval C 30, but Interval D 60 is not symmetric about point A 20.

FIG. 2 is another graphical representation of an example of the invention, showing the principle of finding the best or nearly best bracket, said bracket A representing the range of uncertainty in the control (input) factor, where that bracket includes but it not centered around the maximum single value of the output function within the bracket. Note that, in this example, the highest single value of the performance metric is not included in the chosen interval at all. A method that searches for the highest single value and then computes an interval around that value, as in virtually all of the prior art, would choose interval Z.

Some current heuristic approaches to this problem utilize combinations of simulation and optimization. In a preferred embodiment, this method utilizes a plurality of simulations, each of which corresponds to a set of sample points, where each of the sample points corresponds to a set of values of the control variables. The outputs of these simulations are used as input to a multivariate statistics computer program that plots this set of responses as functions of the control factors, and connecting the points thus determined by smooth surfaces. This process yields what is known to persons skilled in the relevant art as a response surface, that is, a smoothed and connected geometric representation of the plurality of simulation results. This response surface is then input to an optimization computer software program that seeks the highest (or lowest) point on the response surface and may take into account the presence or absence of sharp increases or decreases near the chosen point. Finding a robust optimum, that is, one less sensitive to data perturbations, by this method requires considerable reconsideration and re-estimation and often requires judgmental intervention by a human analyst. The present invention dispenses with calculating the response surface and performs direct search for good patches rather than searching for optimal points possibly surrounded by good patches.

In a preferred embodiment, the system is a computer-based outbound telephone call center. The performance metric is the number of calls completed per hour, subject to a constraint on the number of calls abandoned because no representative was available when the called party answered. The control factors are the number of lines to dial when one or more representatives is idle or expected to be idle soon, and the amount of time by which to anticipate the end of a connection to a called party. A predictive dialing system within such a call center performs a large number of calculations or simulations with different settings of the control factors, each such calculation or simulation producing a set of expected responses.

For the call center embodiment, the present method then calculates a set of circular or rectangular area of given size, collectively covering the space of values. The procedure then calculates, for each such area, one or more performance values associated with that area for that area's values of the control factors. Such an area represents a range of values for each control factor, rather than a single value, such that small variations in one or more control factors will have little effect on performance. In a preferred embodiment, the resulting performance value is the average of the projected performance values for each combination of control factor settings in the given area. In another preferred embodiment, the performance value is the minimum of the projected performance values in the area.

In still another, the performance value is a weighted average of the average and the minimum for each area. The system chooses the placement that yields the highest value of a selected statistical measure of performance, such as the average or the minimum, for that area. The system may, in addition, in repeated applications over time, apply smoothing to move gradually from the previous set of values to the new one. This eliminates the well-known tendency of such systems to jump around among sets of control values, producing some erratic variation in performance.

In another preferred embodiment, aircraft are dynamically re-routed to avoid developing weather hazards. Patches represent travel times and conditions, including anticipated changes over time, such as the predicted passage of storms through the areas. By progressive evaluations of sets of adjoining patches, to be traversed sequentially, the present method identifies possible routes that are likely to avoid the anticipated problems, and the method selects a route that may not be the shortest or least cost, but achieves a low distance and cost while also providing a low probability of disruption by weather.

In another preferred embodiment, ships are dynamically re-routed to avoid hazards, again with some uncertainty about where the hazards might be and where they might travel. The path selected by the method need not be the shortest or least cost, but is a preferable combination of low cost and low exposure to the hazards.

Use of this method in this way yields Robust Adaptive Shortest Path (RASP II™).

In another preferred embodiment, the setting is an artificial intelligence/machine learning system, and the method finds what cognitive scientist Herbert Simon called “satisficing” solutions to situations posed to the system, sacrificing pure optimization for a more robust result that requires far less detailed data and is less affected by random variations in the data or imprecision of the control factors.

The method for a single stochastic optimization comprises the following steps:
1. Define one or more metrics of performance of the system, and one or more control factors.
2. Compute, via simulation or other calculation, estimated performance for each of a plurality of combinations of control factors, said plurality constituting a grid that is relatively dense in the space of possible sets of values.
3. Compute a range for each control factor representing the estimated random variation of that control factor in application. For example, if the 95 percent confidence interval of a control factor is +/−3, the range for this purpose would be 6. These ranges, in combination for all control factors, define a “patch,” that is, a rectangle or hyper-rectangle. A different shape, such as a hyper-ellipsoid, could be used without departing from the scope of this invention.
4. Select a set of such patches that adjoin each other without overlapping and span the space of values of interest. Said space could be the entire space of possible sets of values or a selected subset.
5. For each such patch, designated by its centroid, compute a metric of performance from the performance metrics associated with each point in the patch. In a preferred embodiment, this metric is the minimum value of the performance metric for any point in the patch. In another preferred embodiment, this metric is the mean of the values of the performance metric associated with the points in the patch. Other such statistics of performance can also be utilized without departing from the scope of this invention.
6. Select the patch or a few patches having the highest value of the computed metric.
7. If desired, evaluate patches that partially overlap the patches selected in the previous step, to seek additional improvement.

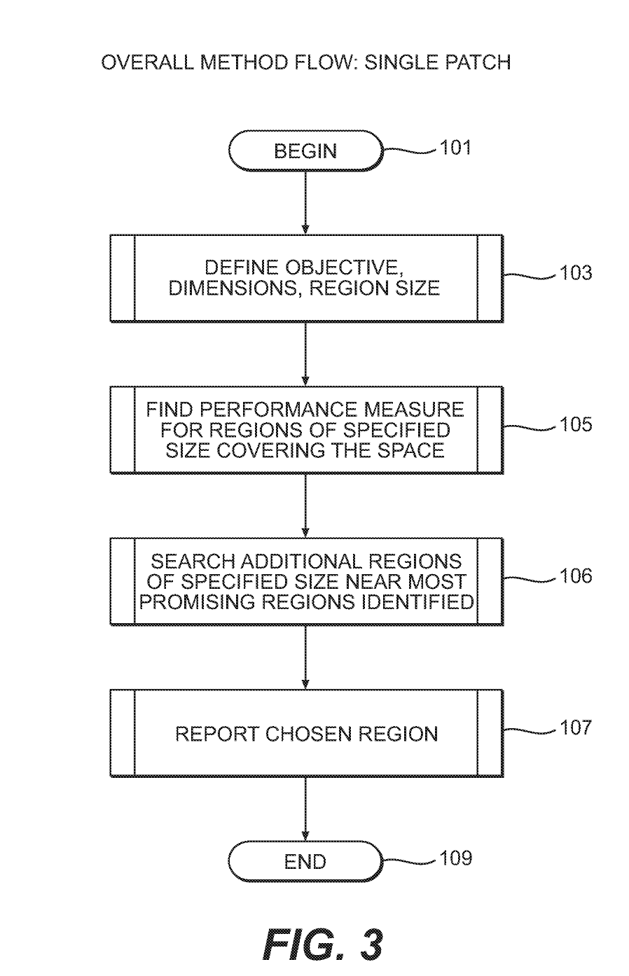

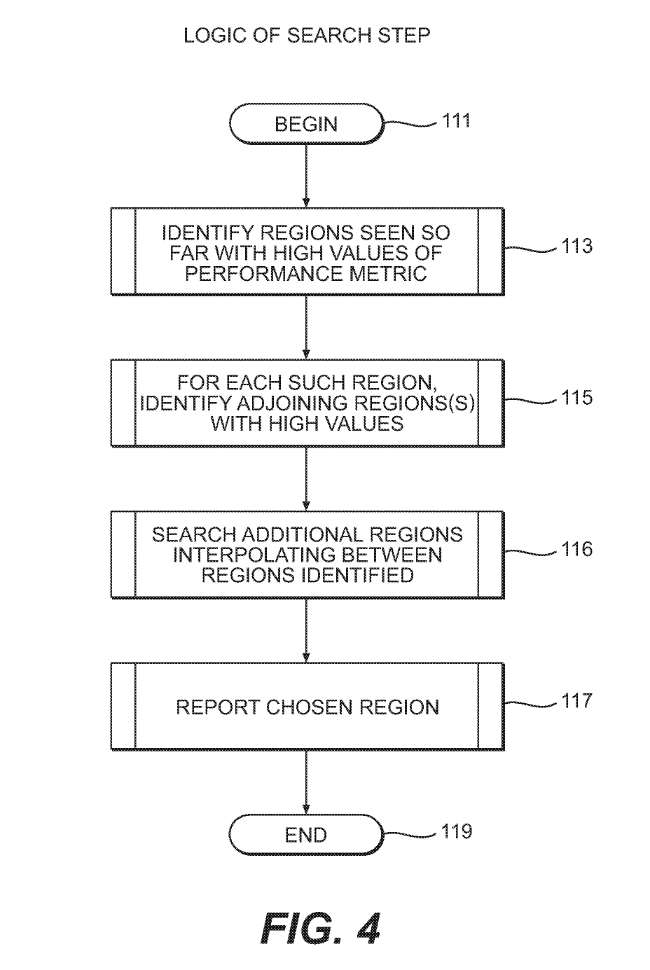

This procedure is depicted in flowchart form in FIG. 3 (overview) and FIG. 4 (details of search procedure in Steps 5 through 7.)

As shown in FIG. 3, the overall method flow single patch begins with the first step 103: Define objective, dimensions, region size. The next step 105 proceeds to find performance measure for regions of specified size covering the space. The next step 106 includes: Search additional regions of specified size near most promising regions identified. The next step 107: Report chosen region, and then ends 109.

As shown in FIG. 4, the logic of search step begins 111. The next step 113 is to identify regions seen so far with high values of performance metric. The next step 115 is: For each such region, identify adjoining region(s) with high values. The next step 116 is to: Search additional regions interpolating between regions identified. The next step 117 is to: Report chosen region, and then ends 119.

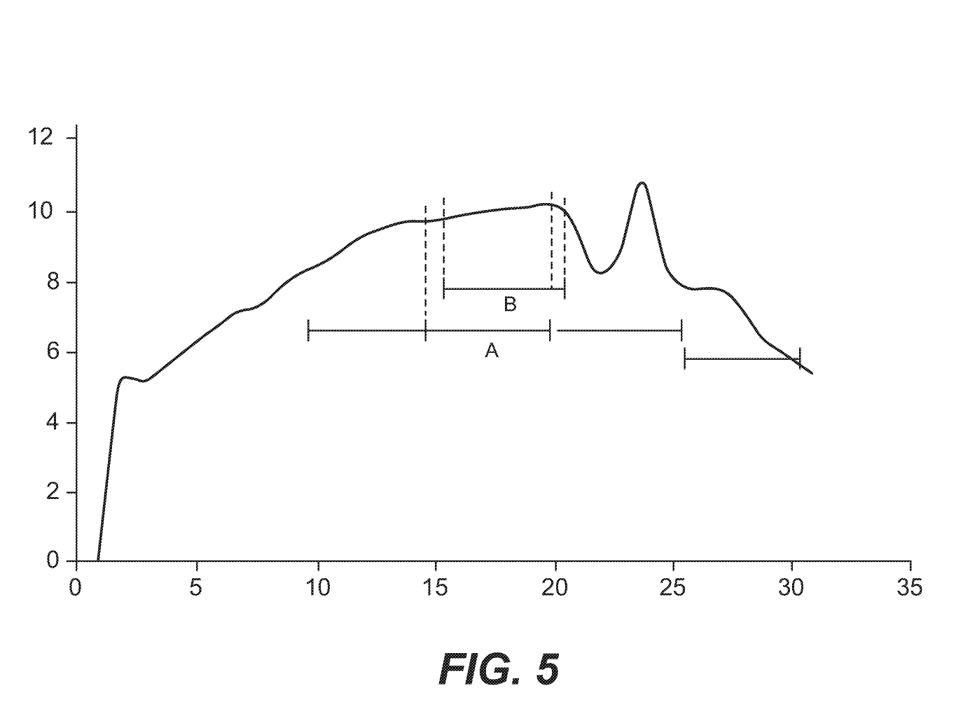

The effect of the refinement described in Step 7 is depicted in FIG. 5, wherein searches of adjoining intervals of the specified size yield interval A as the best choice, but additional searches around interval A lead to the selection of interval B.

The same procedures can be used to find smallest values of the performance metric rather than largest values.

The same procedure can be used to find the patch with some specified combination, such as a weighted average, of high or low average value of the performance metric and small variation of that metric, as, for example, when the objective is to find the highest relatively flat area of a specified size.

While the preferred embodiment described here uses “brute force” exhaustive search of the candidate regions, more efficient search methods could be employed without departing from the scope of this invention. In particular, a preferred embodiment employs the response surface and partial response surface methods used for agriculturally inspired split plot designs and factorial experiments, known to persons skilled in the statistical art. These methods involve depicting the multidimensional data in large layouts of two-dimensional plots, then re-sorting plots based on representative values of the desired metrics for each plot, then investigating in more detail the regions of apparent greatest interest.

In addition, when seeking a sequence or path of best regions, given some assumptions about not having large changes over short time periods, on the second and subsequent searches the efficiency of the search can be greatly improved by hot starting from promising previous regions and eliminating previously unpromising regions. For example, if a region (patch or set of patches) X has an average value of the performance metric, which we seek to maximize, less than the minimum for patch Y, no repeat searches anywhere in region X are needed.

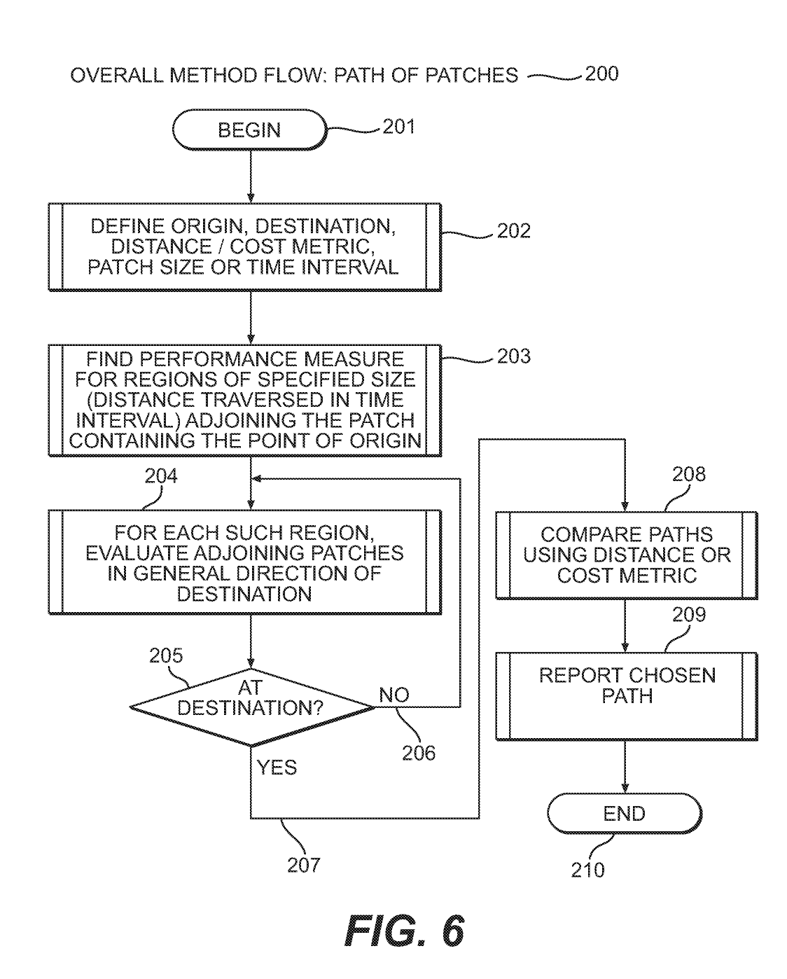

To find a path, the method finds a set of patches that form a connected set across the space and yield the highest or lowest set of values of the performance metrics for said set. In this preferred embodiment, searches for time step t+1 begin at the ends of a small number of promising paths identified in steps 1 through t; no other areas need to be considered. The result is a small number (in a preferred embodiment, three to five) of sets of connected patches, spanning the space of interest from previously specified origin to previously specified destination in some number of time steps. The total values of the performance metrics (typically time or cost) of these paths are then compared to choose the best one. This method is depicted in flowchart form in FIG. 6.

FIG. 6 shows an overall method flow path of patches 200 in the following steps: Begin 201; Define origin, destination, distance/cost metric, patch size or time interval 202; Find performance measure for regions of specified size (distance traversed in time interval) adjoin the patch containing the point of origin 203; For each such region, evaluate adjoining patches in general direction of destination 204; At destination? 205; No 206; Yes 207; Compare paths using distance or cost metric 208; Report chosen path 209; End 210.

In another preferred embodiment, the paths found by the method just described are perturbed by changing some control values and the evaluation of the chosen paths is then repeated, with no additional searching. This procedure helps to identify paths that are more sensitive to hypothesized possible disturbances, and to choose the path, among near-equals, that has the least such sensitivity.

The solution obtained by one exhaustive search, as described above, is refined further by updating estimates of key characteristics in real time, based on observation of actual current behavior, and thereby frequently adjusting the anticipation of system behavior based on changing conditions. Thus if, for example, in the telephone call center, parties called at 6 pm exhibit different durations of conversations with representatives, on average, from those who were called at 5 pm, the system anticipates this change and compensates for it accordingly, choosing a smooth path from the current settings to those that will likely work best as conditions change. The method can be further enhanced, without departing from the scope of this invention, by storing sets of control settings that worked well at previous times, for various times of day, day of week, routings through an area, or other such sets of conditions, and applying the stored conditions as a part of the input to the method as appears helpful.

Thus, for example, in the call center, if percentage of called parties who answer is known to increase considerably from 5 pm to 6 pm, the calculations based on recent performance can be weighted to prefer control settings that anticipate a rising rate of answers.

In some situations, finding a good “satisficing” solution requires finding several “patch” solutions over time and smoothing these solutions to find a path. The present invention combines estimates of good “patches” from a number of grid estimates, over time, and computes from these a set of smoothing parameters to minimize the combined distance—geometrically, to find a closely connected set of preferable “patches” of sets of control factor settings.

These and further and other objects and features of the invention are apparent in the disclosure, which includes the above and ongoing written specification, with the drawing. While the invention has been described with reference to specific embodiments, modifications and variations of the invention may be constructed without departing from the scope of the invention.

I claim:

1. A method comprising finding and identifying a set of points within a large, multidimensional set of points, such that the identified set is highly likely to offer desired values of one or more performance metrics, further comprising the following steps:
defining one or more metrics of performance of the system, and one or more control factors,
computing plural ranges, each a range for each control factor representing the estimated random variation of that control factor in application, the ranges for all control factors and defining patches that are shapes,
selecting a set of such patches that adjoin each other without overlapping and span the space of values of interest,
computing via simulation or other calculation, estimated value of said performance metrics for each of a plurality of patches, each of which represents a combinations of control factors, said plurality of patches constituting a grid that is spread through a set or space of possible sets of values, each such point representing a patch,
for each such patch, designated by its centroid, computing a metric of performance from the performance metrics associated with each point in the patch,
selecting the patch or patches having the most preferred value of the computed metric, and thereby identifying the set of points that is highly likely for providing desired values of one or more performance metrics.

2. The method of claim 1, further comprising evaluating patches that partially overlap the patches selected in the previous step, to seek additional improvement.

3. The method of claim 1, wherein the selecting a set of patches comprises enumerating values associated with patches, evaluated over the set of patches that span the entire space.

4. The method of claim 1, wherein the selecting a set of patches is response surface estimating, treating the set of patches as elements of a split plot or factorial experimental design, or similar estimating methods.

5. The method of claim 1, wherein statistical or other methods are used for selecting only specified patches to evaluate.

6. Repeating applications of the method in claim 1 to identify one or more successions of contiguous regions, within a multidimensional space, each said succession constituting a path to be traversed over time through said multidimensional space.

7. The method of claim 1, wherein a performance metric in each step is shortest distance or shortest time, and paths thus generated are then compared to find the expected approximate shortest path overall.

8. The method of claim 1, wherein characteristics of said multidimensional space or of portions thereof may change over time.

9. The method of claim 1, wherein smoothing parameters are computed to derive a path among selected sets of parameter values, over time, to select a collection of sets of values which yield preferred performance metrics at each time step and have small variation in the control parameters from time step to time step.

10. The method of claim 1, wherein the multidimensional space constitutes elements of information, and the search for approximate preferred values of the desired metric, in patches of values of other variables so that the selecting of a chosen set of patches decreases sensitivity of the desired metric to changes caused by variations on the other variables.

11. The method of claim 10, further comprising using the method in machine learning.

12. The method of claim 1, wherein the shapes are rectangle or hyper-rectangle, a different shape, such as a hyper-ellipsoid.

13. The method of claim 1, wherein the space is the entire space of possible sets of values or a selected subset,

14. The method of claim 1, wherein the metric is the minimum value of the performance metric for any point in the patch.

15. The method of claim 1, wherein the metric is the mean of the values of the performance metric associated with the points in each patch.
